(19) United States
(12) Patent Application Publication
(10) Pub. No.: US 2005/0209540 A1
(43) Pub. Date: Sep. 22, 2005

(54) Hemorrhoid massage device

(76) Inventor: Jiro Takashima, Houston, TX (US)

Correspondence Address: John S. Egbert;Harrison & Egbert, 7th Floor, 412 Main Street, Houston, TX, 77002, US

(21) Appl. No.: 11/121,682

(22) Filed: May 4, 2005

Related U.S. Application Data
(63) Continuation-in-part of application No. 10/424,015, filed on Apr. 28, 2003.
(63) Continuation-in-part of application No. 09/883,900, filed on Jun. 19, 2001, now Pat. No. 6,589,193.
(63) Continuation-in-part of application No. 09/675,436, filed on Sep. 29, 2000, now Pat. No. 6,802,850.

(51) Int. Cl. A61H 21/00

(52) U.S. Cl. 601/135; 601/137

(57) ABSTRACT

A hemorrhoid massage device has a head, a resistor connected to the head and a tail connected to an end of the resistor opposite the head. The head has a size suitable for fitting into a human rectum. The head has a bulbous end with a tapered section narrowing therefrom. The resistor has spindle shape with a curved surface widening so as to define a wide portion of the resistor. The engagement surface has a tapered surface narrowing from this wide portion. The tail has a widening curved surface. A portion of the tapered surface of the head has a diameter equal to a diameter at a point along the widening curved surface of the tail where this point is separated therefrom by one and one and one-half inches.

### RELATED U.S. APPLICATIONS

The present application is a continuation-in-part of U.S. patent application Ser. No. 10/424,015, filed on Apr. 28, 2003, and entitled “Hemorrhoid Treatment and Prostate Massage Apparatus”, presently pending. U.S. patent application Ser. No. 10/424,015 is a continuation-in-part of U.S. patent application Ser. No. 09/883,900, filed on Jun. 19, 2001, and entitled “Hemorrhoid Treatment and Prostate Massage Apparatus”, issued on Jul. 8, 2003 as U.S. Pat. No. 6,589,193. U.S. patent application Ser. No. 09/883,900 was a continuation-in-part of U.S. patent application Ser. No. 09/675,436, filed on Sep. 29, 2000, and entitled “Prostate Massage Apparatus” issued as U.S. Pat. No. 6,802,850 on Oct. 12, 2004.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to devices for the treatment of hemorrhoids. More particularly, the present invention relates to plug-type apparatus that can be inserted into the human anal canal for massaging the internal and external hemorrhoids by self-movement of the device by peristaltic movement of the internal anal canal walls.

### BACKGROUND OF THE INVENTION

One treatment for non-bacterial disorders of the prostate such as chronic prostatitis and a congested prostate is the prostate massage. Some urologists believe that the most effective treatment for such prostatitis is for the doctor to massage the prostate at regular intervals. Other urologists are far less enthusiastic about this procedure, and some do not believe in it at all. To perform such a massage, the physician simply inserts a gloved finger into the rectum and strokes the prostate very gently. It serves to relieve the symptoms of chronic prostatitis by draining accumulated prostatic fluid from the glands and ducts.

Given the difference of opinion of urologists as to the need for prostatic massages, such massages can be difficult to obtain. In any event, the regular and repeated massaging of the prostate can often require frequent visits to the doctor's office. This causes the patient to incur a considerable expense and inconvenience. As such, a need has developed for allowing an individual to carry out his own prostatic massage.

Hemorrhoids can be of severe pain to the individual. In may circumstances, external medicines are applied to the hemorrhoid for the treatment of such hemorrhoidal tissues. However, the external application of such medicines is only moderately effective in the treatment and remedying of severe hemorrhoidal conditions. It is believed that a hemorrhoid massage is most effective in stimulating blood flow in the area of the hemorrhoidal tissues. Heretofore, no device has been developed which effectively stimulates blood flow in such area.

In the past, some patents have issued relating to rectal devices. U.S. Pat. No. 4,542,753, issued on Sep. 24, 1985 to Brenman et al., describes an apparatus and method for stimulating penile erectile tissue. In this invention, a body is provided which may be inserted into the rectum of a user. The body is shaped so as to closely conform to the topological configuration of the rectum within the anal area to a site adjacent to the prostate gland. Electrical circuitry for generating a neurally stimulating electrical signal is located within the body. Electrodes, placed at particular locations on the surface of the body, apply the signal to the user. At least one of the electrodes closely contacts the prostate gland when the body member is operatively disposed, at a region or spot on the prostate gland previously determined to be sensitive to electrical stimulation.

U.S. Pat. No. 5,404,881, issued on Apr. 11, 1995 to Cathaud et al., describes a trans-rectal probe. This trans-rectal probe includes a probe body made of a flexible self-supporting polymer material whose degree of flexibility is designed to enable it to comply with the shape of the rectum while having substantially no compression effect on the rectum when inserted therein. The invention makes it possible to achieve accurate, safe and reliable positioning of an instrument for detection or therapeutic treatment level with the organ to be observed or treated. In particular, this device is designed for treatment of the prostate.

U.S. Pat. No. 2,478,786, issued on Aug. 9, 1949 to H. M. Smallen, describes a prostate gland massaging implement. This implement includes a lever having an interior handle which constitutes a power arm to extend down in front of the abdomen and a substantially horizontal portion extending under the groin and offset laterally to avoid the genital organs. The implement has an upwardly and forwardly bent posterior portion which forms the work arm. This work arm extends into the rectal passage to bear across the frontal wall thereon adjacent the prostate gland. The bent portion between the horizontal and the posterior portions serves as a fulcrum point against the front wall of the rectal opening when the implement is subject to pivotal movement around this point.

The present inventor has two United States patents showing devices for releasing congested prostate fluid. U.S. Pat. No. 5,797,950, issued on Aug. 25, 1998, describes such a device including a head having a size suitable for fitting in a human rectum and through a sphincter. The head has a size suitable for rubbing the prostate gland. A rod is connected to the bottom of the head and extends outwardly therefrom. The rod serves to position the head and guide a movement of the head as the sphincter contracts and relaxes. An abutment surface is affixed to the rod distal the head. The abutment surface contacts the perineum area and pushes up on the perineum area as the sphincter contracts. The rod is a rigid rod having a generally L-shaped or Comprising:—shaped configuration with a radius of curvature such that the head tilts toward the prostate gland as the sphincter contracts and draws the head upwardly. The head has a generally ellipsoidal shape.

U.S. Pat. No. 5,861,009, issued on Jan. 19, 1999 to the present inventor, describes an apparatus for releasing congested prostate fluid having a head with a size suitable for fitting into a human rectum and through the sphincter and having a surface for pushing on the prostate gland. A rod is connected to the bottom of the head and extends outwardly therefrom so as to guide a movement of the head as the sphincter relaxes and contracts. An abutment member is positioned on the rod opposite the head so as to push on the perineum area simultaneously with the head pushing on the prostate gland. The abutment member has a variable angular relationship with the head.

In each of these prior art patents to the present inventor, the rod movably holds the head within the sphincter, and when the external sphincter contracts, the lateral pressure of the external sphincter drives the head upwardly and the rod adds pressure against the perineum area simultaneously. The power of the sphincter's contraction is divided into one for pressure on the prostate and one for pressure onto the perineum area. Under certain circumstances, some persons have felt that the perineum pressure by this rod was strong and uncomfortable.

There are also several anal treatment dilators and various other mechanical devices that intended to facilitate the treatment of one or more human body orifices. For example, U.S. Pat. Nos. 2,763,265 and 3,916,906 each teach devices having proportionateley larger diameters of segments compared with lengths of the segments of the devices. Each of these devices have smallest diameters at the end sections with larger middle sections. This form of construction makes it nearly impossible for these devices to remain within the anal canal.

U.S. Pat. No. 6,589,193 describes a device having a head with a spindle shaped resistor. A portion of the tapered surface of the head has an equal diameter at the portion of the tapered surface of the resistor as separated by one and one and one-half inches from each other so that the device will maintain a balanced position within the anal canal.

It is an object of the present invention to neutrally hold a hemorrhoids massage device within the anal canal and induce a peristaltic movement of the inner wall of the anal canal such that the device is driven slightly backward and forward by peristaltic movements.

It is another object of the present invention to provide a hemorrhoidal massage device whereby the movement of the device within the anal canal effectively massages the internal and external hemorrhoids without aggravating the hemorrhoidal condition.

It is a further object of the present invention to provide a hemorrhoidal massage device in which the peristaltic movement within the anal canal consumes a large amount of energy so as to increase fresh blood circulation to the anorectal area in order to improve hemorrhoidal conditions.

It is still a further object of the present invention to a provide a hemorrhoidal massage device having a relatively small diameter with smooth curved surfaces so as to avoid any aggravation to the hemorrhoidal conditions.

It is another object of the present invention to provide a hemorrhoidal treatment device which is easy to use, relatively inexpensive and easy to manufacture.

These and other objects and advantages of the present invention will become apparent from a reading of the attached specification and appended claims.

### BRIEF SUMMARY OF THE INVENTION

The present invention is a hemorrhoid massage device that comprises a head, a resistor and a tail which are integrally formed together of a polymeric material. The head has a size suitable for fitting into a human rectum. The head has a bulbous end with a tapered section narrowing therefrom.

The resistor has first end and a second end. The resistor has a spindle shape with one end connected to the tapered section of the head. The resistor has a curved section widening from this end so as to define a wide portion of the resistor. The resistor also has a tapered surface narrowing from this wide portion to a second end of the resistor.

The tail has a widening curved surface extending from the second end of the resistor to an end of the tail opposite the bulbous end of the head. A portion of the tapered section of the head has a diameter equal to a diameter at a location along the widening curved surface of the tail where this location is separated of between one and one and one-half inches from the portion of the tapered section of the head. A maximum diameter of the wide portion of the resistor is no greater than a maximum diameter of the head.

The first end of the resistor has a diameter that is no greater than a diameter at the location along the widening curved surface of the tail where the location along this widening curved surface is spaced by one and one and one-half inches from the first end of the resistor. The wide portion of the resistor also has a diameter that is less than half of a length between the portion of the tapered section of the head and the location along the widening curved surface of the tail. The bulbous end of the head is spaced by between two and four inches from the location along the widening curved surface of the tail.

### BRIEF DESCRIPTION OF THE SEVERAL VIEWS OF THE DRAWINGS

FIG. 1 is a side elevational view of the preferred embodiment of the present invention.

FIGS. 2 and 3 illustrate the movement of the device of the present invention as positioned within the anal canal.

### DETAILED DESCRIPTION OF THE INVENTION

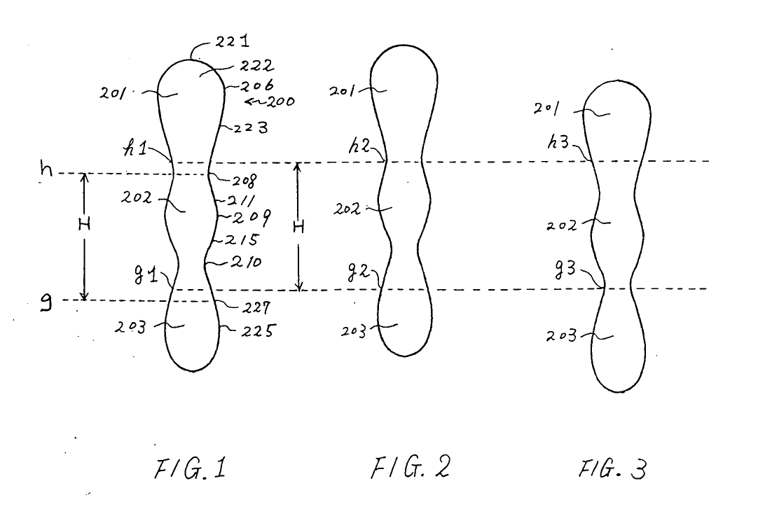

Referring to FIG. 1, there is shown the hemorrhoid massage device 200 in accordance with the preferred embodiment of the present invention. The hemorrhoid massage device 200 includes a resistor 202 with a head 201 connected at one end 208 of the resistor 202 and a tail 203 connected to an opposite end 210 of the resistor 202.

In the preferred embodiment of the present invention, the resistor 202 has a spindle shape. The curved surface 211 widens from the end 208 of the resistor 202 to the wide portion 209 of the resistor 202. The tapered surface 215 narrows from the wide portion 209 of the resistor 202 to the opposite end of the resistor 202.

The head 201 has an end 221 with a bulbous end 222 formed thereat and a tapered section 223 extending from the end 206 of the bulbous portion 222 to the end 208 of the resistor 202. This tapered section 223 narrows in diameter as it approaches the end 208 of resistor 202. The bulbous end 222 should have a size suitable for fitting into a human rectum. The end 221 should be suitably smooth and curved so as to facilitate insertion of the bulbous end 222 into the anal canal.

The tail 203 has widening curved surface 225 extending from the opposite end 210 of the resistor 202. The tail 203, as illustrated in FIG. 1, has a curved surface at the end opposite end 221 of head 201.

The tapered section 223 of the head 201 has a portion h1. The widening curved surface 225 of the tail 203 has a point g1 therealong. The point g1 and the portion h1 are separated by one and one and one-half inches. This distance represents the length of the human sphincter H. Typically, the length of the human sphincter will be between one and one and one-half inches depending on the size of the individual. The diameter at the portion h1 of the tapered section 223 of the head 201 has equal diameter as the diameter of the widening curved surface 225 at point g1. The ideal diameter of the wide portion 209 of the resistor 202 is less than a half of the length between h1 and g1. The diameter of the wide portion 209 of the resistor 202 is no more than a maximum diameter of the head 201. A diameter of the end 208 of the resistor 202 is no more than a diameter of at a location 227 of the widening curved surface 225 of the tail 203 as separated of between one and one and one-half inches from the end 208 of the resistor 202. The ideal length from the point g1 of the widening curved surface 225 to the end 221 of the device 200 is between two and four inches.

FIG. 1 illustrates the first position of the device 200 within the anal canal. The device 200 is inserted into the anal canal and maintains a balanced position. The broken line g shows the lower edge of the anal canal. The broken line h shows the upper edge of the anal canal. When the diameter of the device 200 at the upper edge h1 of the anal canal is equal to the diameter of the device at the lower edge g1, and the lateral pressure of the sphincter is distributed equally throughout the entire area of the anal canal, the thrust force added to the device by the lateral pressure of the anal canal is balanced across the device 200. When the device 200 is in this position within the anal canal, it receives many kinds of forces. These forces can include a wave-like peristaltic motion, lateral pressure and evacuative pressure. The various surfaces of the device 200 convert these forces to directional thrust forces.

FIG. 2 illustrates the device 200 as pushed upwardly to a second position by the unbalanced forces. When peristaltic motion is added to the second tapered surface 215 of the resistor 202, the device 200 will move upwardly. This is result of the diameter of the device 200 at the upper edge h2 of the sphincter being smaller than the diameter of the device 200 at the lower edge g2 of the sphincter. The lateral pressure of the sphincter pulls the device back to the second opposite (as illustrated in FIG. 1).

FIG. 3 shows the device 200 as pushed down to a third position by either voluntary or involuntary evacuative pressure. The diameter of the head of 201 at the upper edge h3 of the sphincter is larger than the diameter of the tail 203 at the lower edge g3 of the sphincter. The lateral pressure of the sphincter then pushes the devices upwardly to the first balanced position (as illustrated in FIG. 1). As a result, the device 200 will move backwardly and forwardly as result of these pressures. These continuous small movements help to massage the hemorrhoidal tissues and increase blood circulation in the area.

The foregoing disclosure and description of the invention is illustrative and explanatory thereof. Various changes in the details of the illustrated construction can be made within the scope of the appended claims without departing from the true spirit of the present invention. The present invention should only be limited by the following claims and their legal equivalents.

1. A hemorrhoid message device comprising:
a head having a size suitable for fitting into a human rectum, said head having a bulbous end with a tapered section narrowing therefrom;
a resistor having a first end and second end, said resistor having a spindle shape with one end connected to said tapered section of said head, said resistor having a curved surface widening from said one end so as to define a wide portion of said resistor, said resistor having a tapered surface narrowing from said wide portion to said second end; and
a tail having a widening curved surface extending from said second end of said resistor to an end of said tail opposite said bulbous end of said head, a portion of said tapered section of said head having a diameter equal to a diameter at a location along said widening curved surface of said tail where said location is separated by a distance of between one and one and one-half inches from said portion of said tapered surface of said head, a diameter of said wide portion of said resistor being no greater than a maximum diameter of said head.

2. The device of claim 1, said first end of said resistor having a diameter that is no greater than a diameter at said location along said widening curved surface of said tail where said location along said widening curved surface is spaced by one and one and one-half inches from said first end of said resistor.

3. The device of claim 1, said wide portion of said resistor having a diameter that is less than half of a length between said portion of said tapered section of said head and said location along said widening curved surface of said tail.

4. The device of claim 1, said bulbous end of said head being spaced by between 2 and 4 inches from said location along said widening curved surface of said tail.

5. The device of claim 1, said head, said resistor and said tail being integrally formed together of a polymeric material.

6. A hemorrhoid message device comprising:
a head having a size suitable for fitting into a human rectum, said head having a bulbous end with a tapered section narrowing therefrom;
a resistor having a first end and second end, said resistor having a spindle shape with one end connected to said tapered section of said head, said resistor having a curved widening from said one end so as to define a wide portion of said resistor, said resistor having a tapered surface narrowing from said wide portion to said second end; and
a tail having a widening curved surface extending from said second end of said resistor to an end of said tail opposite said bulbous end of said head, said first end of said resistor having a diameter that is equal to a diameter at a location along said widening curved surface of said tail where said location along said widening curved surface is spaced by one and one and one-half inches from said tapered section of said head, said first end of said resistor having a diameter that is no greater at said location along said widening curved surface of said tail where said location is spaced by one and one-half inches from said first end of said resistor.

7. The device of claim 6, said bulbous end of said head being spaced by between two and four inches from said point along said widening curved surface of said tail.

8. The device of claim 6, said head, said resistor and said tail are integrally formed together of a polymeric material.
